(19) United States
(12) Patent Application Publication
(10) Pub. No.: US 2025/0193531 A1
(43) Pub. Date: Jun. 12, 2025

(54) IMAGE PICKUP APPARATUS CAPABLE OF OBTAINING PLURALITY OF IMAGES WITH DIFFERENT SLOW SHUTTER EFFECTS WITH ONE PHOTOGRAPHING INSTRUCTION, CONTROL METHOD FOR IMAGE PICKUP APPARATUS, AND STORAGE MEDIUM

(71) Applicant: CANON KABUSHIKI KAISHA, Tokyo (JP)

(72) Inventor: KAZUKI SATO, Kanagawa (JP)

(21) Appl. No.: 18/974,406

(22) Filed: Dec. 9, 2024

(30) Foreign Application Priority Data
Dec. 11, 2023 (JP) 2023-208564

(51) Int. Cl. H04N 23/743; H04N 23/62; H04N 23/76; H04N 25/53

(52) U.S. Cl. CPC H04N 23/743; H04N 23/62; H04N 23/76; H04N 25/53

(57) ABSTRACT

An image pickup apparatus including an image pickup unit, includes a setting unit that, when performing bracket photographing, sets a first exposure time and at least two exposure times different from the first exposure time and using the first exposure time as a reference, in response to a user operation, a determining unit that determines a split exposure time and the number of times of consecutive photographing, a split exposure unit that performs the consecutive photographing with the image pickup unit based on the split exposure time and the number of times of the consecutive photographing, and generates a plurality of split exposure images, a compositing unit that composites the plurality of split exposure images to generate composite images, and a saving unit that saves the plurality of split exposure images and the composite images in accordance with the first exposure time and the at least two exposure times.

### BACKGROUND

### Technical Field

One disclosed aspect of the embodiments relates to an image pickup apparatus, a control method for the image pickup apparatus, and a storage medium, and more particularly relates to an image pickup apparatus that records images with slow shutter effects, a control method for the image pickup apparatus, and a storage medium.

### Description of the Related Art

As a photographing technique based on long time exposure, there is slow shutter photographing that impresses the movement of a moving subject such as water flowing through a waterfall or a river. In the slow shutter photographing, since the expression or impression of the photograph that a user is able to photograph changes depending on the length of the exposure time, it is necessary to perform photographing repeatedly until a photograph that is satisfactory to the user is photographed. However, in the case of repeatedly performing photographing while changing the exposure time, it is not possible to record images with different slow shutter effects of the same scene.

On the other hand, there are conventional techniques that achieve pseudo long time exposure. For example, Japanese Laid-Open Patent Publication (kokai) No. 2022-125117 has disclosed a method of compositing images, which have been obtained by repeatedly performing photographing at a specific interval, so as to achieve a specific brightness. In addition, Japanese Laid-Open Patent Publication (kokai) No. 2007-202050 has disclosed a method of recording images with different exposure values of the same scene as bracket images by repeatedly aligning and adding a plurality of photographed images together and storing the images.

However, in the prior art disclosed in Japanese Laid-Open Patent Publication (kokai) No. 2022-125117, since the brightness of the image changes, it is not possible to record images in which only the slow shutter effect is different. In addition, in the prior art disclosed in Japanese Laid-Open Patent Publication (kokai) No. 2007-202050, since the photographed images are aligned, it is not possible to record images with slow shutter effects, in which the movement of a moving subject is photographed.

### SUMMARY

One disclosed aspect of the embodiments provides an image pickup apparatus that comprises an image pickup unit which picks up an image of a subject, comprising at least one processor, and a memory coupled to the processor storing instructions that, when executed by the processor, cause the processor to function as an exposure time setting unit that, in a case of performing bracket photographing, sets a first exposure time and at least two exposure times, which are different from the first exposure time and use the first exposure time as a reference, in response to a user operation, a determining unit that determines a split exposure time and the number of times of consecutive photographing of four or more in accordance with the first exposure time and the at least two exposure times that have been set by the exposure time setting unit, a split exposure unit that performs the consecutive photographing with the image pickup unit based on the split exposure time and the number of times of the consecutive photographing of four or more that have been determined, and generates a plurality of split exposure images, a compositing unit that composites the plurality of split exposure images generated by the split exposure unit in accordance with the first exposure time and the at least two exposure times that have been set by the exposure time setting unit to generate composite images, and a saving unit that saves the plurality of split exposure images and the composite images composited by the compositing unit in accordance with the first exposure time and the at least two exposure times.

Another disclosed aspect of the embodiments provides an image pickup apparatus that comprises an image pickup unit which picks up an image of a subject, comprising at least one processor, and a memory coupled to the processor storing instructions that, when executed by the processor, cause the processor to function as a setting unit that allows a user to set a first exposure time and one or more second exposure times different from the first exposure time, a determining unit that determines a split exposure time and the number of times of consecutive photographing in accordance with the first exposure time and the second exposure times that have been set by the setting unit, a control unit that controls the consecutive photographing with the image pickup unit based on the split exposure time and the number of times of the consecutive photographing that have been determined, a compositing unit that composites a plurality of split exposure images picked up based on the split exposure time determined in accordance with the first exposure time and the second exposure times that have been set by the setting unit to generate composite images, and a saving unit that saves (records) the composite images corresponding to the first exposure time and the second exposure times.

According to the disclosure, it is possible to obtain a plurality of images with different slow shutter effects with one photographing instruction.

Further features of the present disclosure will become apparent from the following description of exemplary embodiments with reference to the attached drawings.

### BRIEF DESCRIPTION OF THE DRAWINGS

FIG. 1 is an external appearance view of a digital camera as an example of an image pickup apparatus according to one or more aspects of the present disclosure.

FIG. 2 is a block diagram that shows a hardware configuration of the digital camera.

FIG. 3 is an example of an exposure time setting screen according to one or more aspects of the present disclosure displayed on a display unit of the digital camera shown in FIG. 1.

FIG. 4 is a flowchart of an image pickup processing according to one or more aspects of the present disclosure, which includes an exposure time setting processing, and a split exposure compositing processing based on an exposure time setting that has been set.

FIG. 5 is a diagram for explaining a setting interval of additionally-set exposure times for slow shutter images in bracket photographing.

FIG. 6A is a diagram for explaining a method of additionally saving slow shutter images in bracket photographing.

FIG. 6B is a diagram that shows a continuation of FIG. 6A.

FIG. 7A is a diagram that shows examples of a split exposure time, the number of times of consecutive photographing, and a group of images to be saved based on settings on respective exposure time setting screens shown in FIG. 5.

FIG. 7B is a diagram that shows a continuation of FIG. 7A.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

Hereinafter, an embodiment of the disclosure will be described with reference to the drawings.

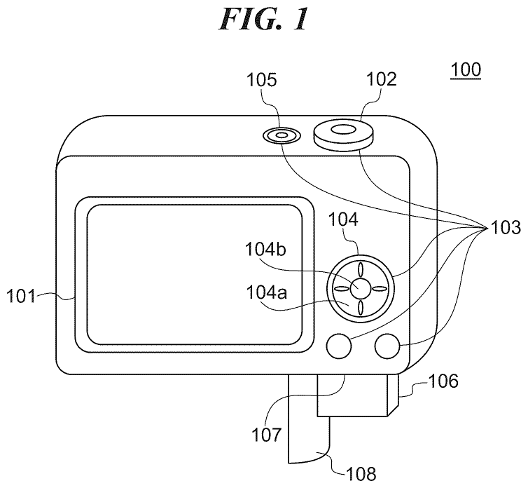

FIG. 1 is an external appearance view of a digital camera 100 as an example of an image pickup apparatus according to the embodiment.

As shown in FIG. 1, the digital camera 100 includes a display unit 101, an operation unit 103, a recording medium 106, a recording medium slot 107, and a lid 108.

The operation unit 103 is an operation member including various kinds of switches and various kinds of buttons, such as a shutter button 102 for issuing a photographing instruction, a controller wheel 104, and a power switch 105, for accepting various kinds of operations from a user. The controller wheel 104 is an operation member whose outer periphery is capable of being rotation-operated, and has a four-direction button 104a and a SET button 104b on its inner side. The four-direction button 104a is a button capable of being pressed in four directions: up, down, left, and right. The SET button 104b is a push button for determining the contents of a user operation. The power switch 105 is a push button for switching the power on and off.

The display unit 101 is a display unit that includes a liquid crystal display (an LCD) for displaying images and various kinds of information. The display contents of the display unit 101 include a photographing mode selection screen, a menu, displays for settings of photographing conditions such as an ISO sensitivity, an aperture value, a shutter speed, etc., and a display for photographing information. The photographing conditions such as the shutter speed and exposure at the time of photographing are capable of being inputted and set by the user operating the four-direction button 104a and the SET button 104b from a menu screen displayed on the display unit 101 or a setting section superimposed and displayed on a live viewing. In addition, the display unit 101 and the operation unit 103 may be integrated as a touch panel display that is capable of being operated by touch. In this case, the user is also able to input and set the photographing conditions by performing touch operations by touching a panel of the touch panel display.

The recording medium 106 is a recording medium such as a memory card or a hard disk. The recording medium slot 107 is a slot for storing (housing) the recording medium 106. The recording medium 106 which has been stored (housed) in the recording medium slot 107 is capable of communicating with the digital camera 100. The lid 108 is a lid for the recording medium slot 107.

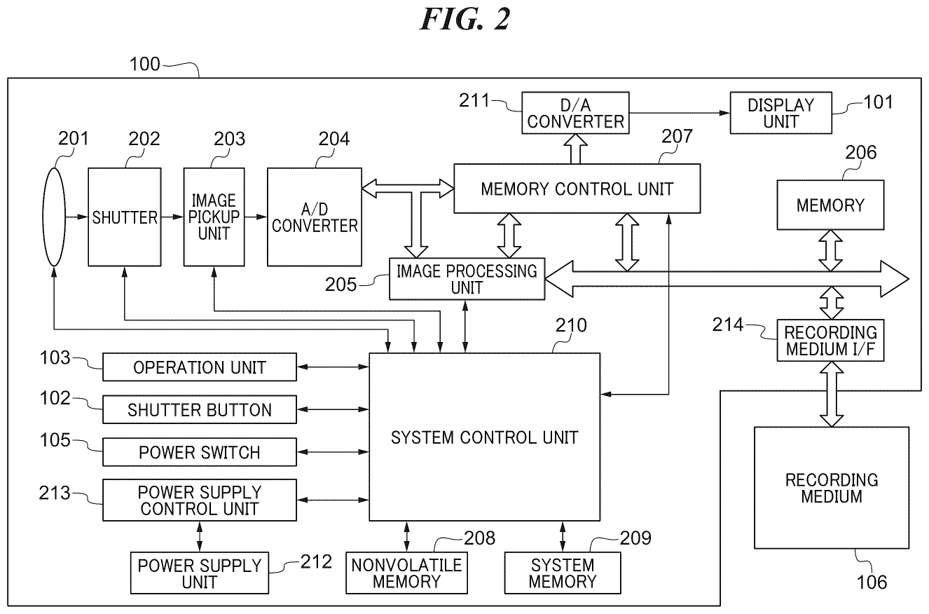

FIG. 2 is a block diagram that shows a hardware configuration of the digital camera 100. It should be noted that the same reference numerals are used for the components that have been described with reference to FIG. 1, and redundant descriptions will be omitted.

As shown in FIG. 2, the digital camera 100 includes a photographing lens 201, a shutter 202, an image pickup unit 203, an A/D converter 204, an image processing unit 205, a memory 206, a memory control unit 207, a nonvolatile memory 208, and a system memory 209. In addition, the digital camera 100 includes a system control unit 210, a D/A converter 211, a power supply unit 212, and a power supply control unit 213.

The photographing lens 201 is a lens group that includes a zoom lens with an aperture function and a focus lens. The shutter 202 opens and closes a front curtain and a rear curtain to bring an image pickup surface of the image pickup unit 203 into an exposed state or a light-shielded state. The image pickup unit 203 is configured with a CCD imaging element, a CMOS imaging element, or the like that converts an optical image of a subject into electrical signals and picks up image data. The A/D converter 204 converts analog signals into digital signals. The A/D converter 204 is used to convert analog signals outputted from the image pickup unit 203 into digital signals.

The image processing unit 205 performs a so-called development processing, which includes a predetermined pixel interpolation, a resizing processing such as reduction, and a color conversion processing, with respect to image data from the A/D converter 204 or image data from the memory control unit 207. In addition, the image processing unit 205 performs a predetermined calculation processing by using the image data picked up by the image pickup unit 203, and performs a TTL type auto white balance processing (a TTL type AWB processing) based on the obtained calculation result. Moreover, the image processing unit 205 performs a compositing processing, which generates composite image data, according to a compositing processing method that has been set in the system control unit 210. The image processing unit 205 may perform the compositing processing before performing the development processing, or may perform the compositing processing with respect to the development-processed image data. It should be noted that in the compositing processing method of the present embodiment, N pieces of image data photographed with split exposure (data of N images photographed with split exposure) are calculated according to an additive average compositing method to generate the composite image data. The luminance value of each of the N pieces of image data before compositing is set to I_i (x, y) (i=1 to N, and x and y represent coordinates within the screen), and the luminance value of the image after compositing these N images is set to I (x, y). In this case, the calculation based on the additive average compositing method is expressed as I (x, y)=(I_1 (x, y)+I_2 (x, y)+ . . . +I_N (x, y))/N, and the composite image data is generated by performing an average value processing of the luminance values of the N images for each pixel. It should be noted that the compositing processing method is not limited to the additive average compositing method, but may be an additive compositing method, a comparative light compositing method, or a comparative dark compositing method. The output data from the A/D converter 204 is written directly into the memory 206 via the image processing unit 205 and the memory control unit 207, or via the memory control unit 207.

The memory 206 stores the image data obtained by the image pickup unit 203 and converted into digital data by the A/D converter 204, and image data to be displayed on the display unit 101. The memory 206 has a storage capacity sufficient to store moving images and audio for a predetermined time, and a predetermined number of still images.

The nonvolatile memory 208 is an electrically erasable and recordable memory, and is, for example, an electrically erasable programmable read-only memory (an EEPROM). The nonvolatile memory 208 stores constants, programs, etc. for the operation of the system control unit 210. Here, the programs refer to programs for executing various flowcharts described below in the present embodiment.

The system memory 209 is a memory using a random access memory (a RAM), and the constants and variables for the operation of the system control unit 210, and the programs, etc. read out from the nonvolatile memory 208 are loaded into the system memory 209.

The system control unit 210 controls the entire digital camera 100 and executes the programs recorded (stored) in the nonvolatile memory 208 to realize each processing of the present embodiment, which will be described below. The system control unit 210 determines a split exposure time and the number of times of consecutive photographing for generating images corresponding to an exposure time setting that has been set by the user operating the operation unit 103.

The system control unit 210 also performs display control to display image data for display, which has been written into the memory 206, on a display such as an LCD by controlling the memory 206, the D/A converter 211, the display unit 101, etc.

When a so-called half-press operation of the shutter button 102 is performed, the shutter button 102 transmits a first shutter switch signal SW1 (a photographing preparation instruction) to the system control unit 210. In addition, when a so-called full-press operation of the shutter button 102 is performed, the shutter button 102 transmits a second shutter switch signal SW2 (the photographing instruction) to the system control unit 210. When the system control unit 210 receives the first shutter switch signal SW1, the system control unit 210 starts operations such as an autofocus processing (an AF processing), an auto exposure processing (an AE processing), an auto white balance processing (an AWB processing), and a pre-flash processing (an EF processing). In addition, when the system control unit 210 receives the second shutter switch signal SW2, the system control unit 210 starts a series of photographing processing operations from reading out signals from the image pickup unit 203 to writing image data into the recording medium 106 based on the split exposure time and the number of times of the consecutive photographing that have been determined.

The respective operation members of the operation unit 103 are assigned appropriate functions for different situations by, for example, selection-operating various functional icons displayed on the display unit 101, and act as various functional buttons. The functional buttons include, for example, an end button, a back button, an image forward button, a jump button, a narrowing down button, an attribute change button, and a menu button. For example, when the menu button is pressed, a menu screen in which various kinds of settings are capable of being made is displayed on the display unit 101. The user is able to intuitively perform various kinds of settings by using the menu screen displayed on the display unit 101, the four-direction button 104a capable of being pressed in four directions: up, down, left, and right, and the SET button 104b. The controller wheel 104 is an operation member capable of being rotation-operated and included in the operation unit 103, and is used together with the four-direction button 104a located on the inner side thereof to, for example, instruct a selection item. When the controller wheel 104 is rotation-operated, an electrical pulse signal is generated according to the operation amount, and the system control unit 210 controls each unit of the digital camera 100 based on this pulse signal. According to this pulse signal, it is possible to determine an angle at which the controller wheel 104 has been rotation-operated, how many times the controller wheel 104 has rotated, etc. It should be noted that the controller wheel 104 may be any operation member as long as it is capable of detecting a rotation operation. For example, the controller wheel 104 may be a dial operation member that generates a pulse signal by the controller wheel 104 itself rotating in response to a rotation operation performed by the user. Alternatively, the controller wheel 104 may be an operation member including a touch sensor (a so-called touch wheel) that detects a rotation action of the user's finger or the like on the controller wheel 104 without the controller wheel 104 itself rotating.

The power supply control unit 213 includes a battery detection circuit (not shown), a DC-DC converter (not shown), a switching circuit (not shown) for switching between blocks to be energized, etc., and detects whether or not a battery has been attached, a type of the battery, and a remaining battery level. In addition, the power supply control unit 213 controls the DC-DC converter based on the detection results and an instruction from the system control unit 210 and supplies the respective units including the recording medium 106 with necessary voltage for a necessary period of time.

The power supply unit 212 is configured by a primary battery such as an alkaline battery or a lithium battery, a secondary battery such as a NiCd battery, a NiMH battery, or a lithium-ion battery, an AC adapter, or the like.

A recording medium I/F 214 is an interface with the recording medium 106 that is a memory card, a hard disk, or the like. The recording medium 106 is a recording medium such as a memory card for recording the photographed images, and is, for example, a semiconductor memory, a magnetic disk, or the like.

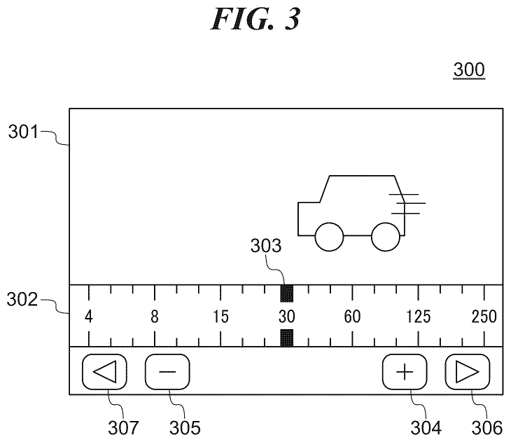

FIG. 3 is an example of an exposure time setting screen 300 according to the present embodiment displayed on the display unit 101.

As shown in FIG. 3, the exposure time setting screen 300 includes a live view 301, an exposure time setting section 302, a set exposure time 303, a + button 304, a − button 305, a right arrow button 306, and a left arrow button 307. In addition, although not shown in FIG. 3, the exposure time setting screen 300 includes an OK button that is pressed by the user to determine the exposure time that has been set on this screen.

The exposure time setting section 302 is a setting section that is superimposed and displayed on the live view 301, and displays the set exposure time 303 (a first exposure time) that has been selected by the user, etc. The user is able to change the set exposure time 303 by a touch operation or by operating a button assigned to the operation unit 103. Moreover, the set exposure time 303 may be changed by operating the controller wheel 104.

The + button 304 and the − button 305 (an additional exposure time setting section) set additional exposure times for performing setting of so-called bracket photographing in response to a user operation. Here, the bracket photographing refers to photographing in which, in addition to generating an image equivalent to an image obtained by an exposure of the set exposure time 303, images equivalent to images obtained by exposures of additional exposure setting times different from the set exposure time 303 are generated with one photographing instruction. By pressing the + button 304 and the − button 305, scales indicating the setting of the bracket photographing, in which the set exposure time 303 is used as a reference and images photographed with a long exposure time and a short exposure time are additionally generated and saved (stored), are displayed. By pressing the + button 304 (a first interval changing section), the interval of the bracket photographing using the set exposure time 303 as the reference is increased. When the − button 305 (a second interval changing section) is pressed, the interval of the bracket photographing using the set exposure time 303 as the reference is decreased.

When the user presses the right arrow button 306 (a short-exposure-time side exposure time setting section), the right arrow button 306 is able to move the scales (additionally-set exposure times) of the bracket photographing using the set exposure time 303 as the reference to the short exposure time side. In addition, when the user presses the left arrow button 307 (a long-exposure-time side exposure time setting section), the left arrow button 307 is able to move the scales (the additionally-set exposure times) of the bracket photographing using the set exposure time 303 as the reference to the long exposure time side.

In the present embodiment, as an example, the case has been described in which the exposure time setting screen displayed on the display unit 101 (the LCD) has been touch-operated, but the operation of the exposure time setting screen may be performed by using the controller wheel 104 to which processing corresponding to each touch operation has been assigned.

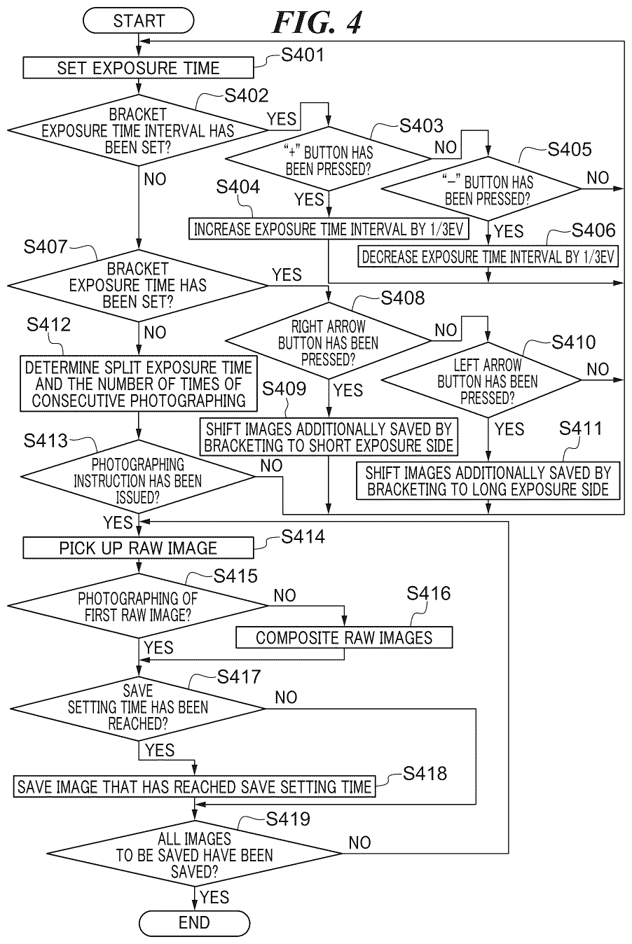

FIG. 4 is a flowchart of an image pickup processing according to the present embodiment, which includes an exposure time setting processing, and a split exposure compositing processing based on exposure times that have been set.

The image pickup processing shown in FIG. 4 is a processing executed by the system control unit 210 (an exposure time setting unit), with steps S401 to S411 being the exposure time setting processing, and steps S412 to S419 being the split exposure compositing processing.

In the step S401, the system control unit 210 accepts a user operation with respect to the exposure time setting section 302 and sets an exposure time.

In the step S402, the system control unit 210 determines whether or not to operate the + button 304 or the − button 305 and perform setting of images to be saved by the bracket photographing. In the case of performing the setting of the images to be saved by the bracket photographing (YES in the step S402), the image pickup processing proceeds to the step S403, and otherwise (NO in the step S402), the image pickup processing proceeds to the step S407.

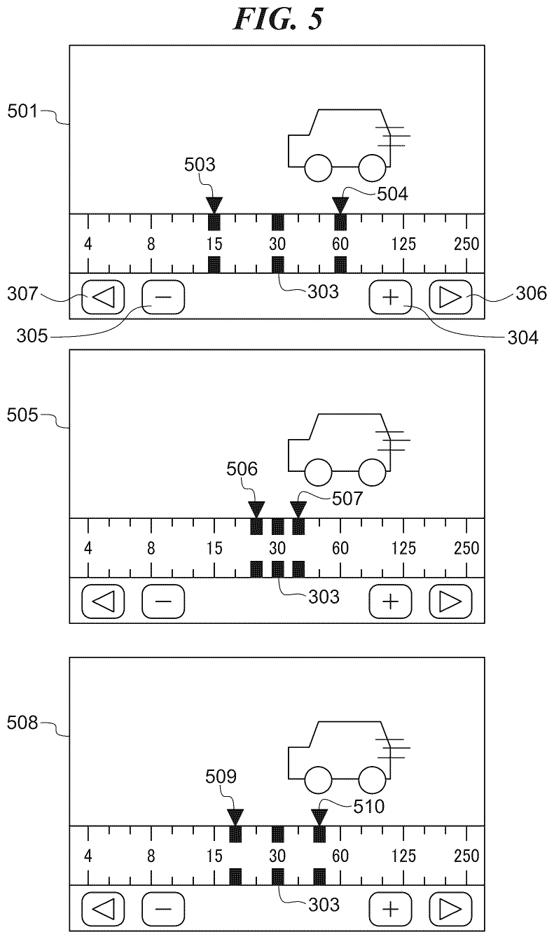

Here, a setting interval of the additionally-set exposure times for slow shutter images in the bracket photographing will be described with reference to FIG. 5.

An exposure time setting screen 501 is a screen that displays the additionally-set exposure times that are saved in the bracket photographing in the case that the + button 304 has been pressed once after the set exposure time 303 has been set to 1/30 second as shown in FIG. 3 in the step S401.

Additionally-set exposure times 503 and 504 indicate exposure times that are additionally saved (stored) in addition to the set exposure time 303 as the exposure times for the slow shutter images. The additionally-set exposure time 503 indicates that a slow shutter image with an exposure time ( 1/15 second) equivalent to twice the set exposure time 303 ( 1/30 second) is to be additionally saved (stored). The additionally-set exposure time 504 indicates that a slow shutter image with an exposure time ( 1/60 second) equivalent to ½ of the set exposure time 303 ( 1/30 second) is to be additionally saved (stored). In other words, the exposure time setting screen 501 is able to notify the user that the slow shutter images with the additionally-set exposure time 503 ( 1/15 second), the set exposure time 303 ( 1/30 second), and the additionally-set exposure time 504 ( 1/60 second) are capable of being obtained by the bracket photographing.

In addition, the setting interval of the additionally-set exposure times that are saved by the bracket photographing does not have to be a double interval or a ½ interval (that is, does not have to be at a pitch of 1 EV (EV refers to exposure value)) as in the exposure time setting screen 501, but may be at a pitch of a predetermined EV (for example, at a pitch of ⅓ EV or at a pitch of ½ EV). For example, it is possible to set the split exposure time of the image pickup unit 203 at a pitch of ⅓ EV. In this case, the setting interval of the exposure times that are saved by the bracket photographing is set at a pitch of ⅓ EV.

Exposure time setting screens 505 and 508 are screens in which the setting of the exposure times for the bracket photographing has been changed at a pitch of ⅓ EV from the setting state on the exposure time setting screen 501.

The exposure time setting screen 505 shows an example in which, after the set exposure time 303 has been set to 1/30 second as shown in FIG. 3 in the step S401, the + button 304 is pressed once, and the exposure time interval, which is saved by the bracket photographing, has been increased once at a pitch of ⅓ EV. In other words, the exposure time setting screen 505 is able to notify the user that the slow shutter images with an additionally-set exposure time 506 ( 1/25 second), the set exposure time 303 ( 1/30 second), and an additionally-set exposure time 507 ( 1/40 second) are capable of being obtained by the bracket photographing.

The exposure time setting screen 508 shows an example in which the + button 304 is pressed once on the exposure time setting screen 505, and the exposure time interval, which is saved by the bracket photographing, has been increased once at a pitch of ⅓ EV. In other words, the exposure time setting screen 508 is able to notify the user that the slow shutter images with an additionally-set exposure time 509 ( 1/20 second), the set exposure time 303 ( 1/30 second), and an additionally-set exposure time 510 ( 1/50 second) are capable of being obtained by the bracket photographing.

Returning to FIG. 4, in the step S403, the system control unit 210 determines whether or not the +button 304 has been pressed. In the case that the + button 304 has been pressed (YES in the step S403), the image pickup processing proceeds to the step S404, and otherwise (NO in the step S403), the image pickup processing proceeds to the step S405.

In the step S404, the system control unit 210 uses the exposure time that has been set in the step S401 as a reference, and increases the exposure time interval of the slow shutter images to be additionally saved (stored) by the bracket photographing. For example, in the case that the + button 304 has been pressed once on the exposure time setting screen 505, the screen transitions to the exposure time setting screen 508, and in the case that the + button 304 has been pressed once on the exposure time setting screen 508, the screen transitions to the exposure time setting screen 501. After that, the image pickup processing returns to the step S401.

In the step S405, the system control unit 210 determines whether or not the − button 305 has been pressed. In the case that the − button 305 has been pressed (YES in the step S405), the image pickup processing proceeds to the step S406, and otherwise (NO in the step S405), the image pickup processing returns to the step S401.

In the step S406, the system control unit 210 decreases the exposure time interval that has been set immediately before (here, the exposure time interval that has been set in the step S401). For example, in the case that the − button 305 has been pressed once on the exposure time setting screen 501, the screen transitions to the exposure time setting screen 508, and in the case that the − button 305 has been pressed once on the exposure time setting screen 508, the screen transitions to the exposure time setting screen 505. After that, the image pickup processing returns to the step S401.

In the step S407, the system control unit 210 determines whether or not to operate the right arrow button 306 or the left arrow button 307 and additionally save the slow shutter images by the bracket photographing. In the case of additionally saving the slow shutter images (YES in the step S407), the image pickup processing proceeds to the step S408. On the other hand, in the case of not additionally saving the slow shutter images (NO in the step S407), that is, in the case that the OK button has been pressed by the user on the exposure time setting screen, the image pickup processing proceeds to the step S412.

In the step S408, the system control unit 210 determines whether or not the right arrow button 306 has been pressed. In the case that the right arrow button 306 has been pressed (YES in the step S408), the image pickup processing proceeds to the step S409, and otherwise (NO in the step S408), the image pickup processing proceeds to the step S410.

In the step S410, the system control unit 210 determines whether or not the left arrow button 307 has been pressed. In the case that the left arrow button 307 has been pressed (YES in the step S410), the image pickup processing proceeds to the step S411, and otherwise (NO in the step S410), the image pickup processing returns to the step S401.

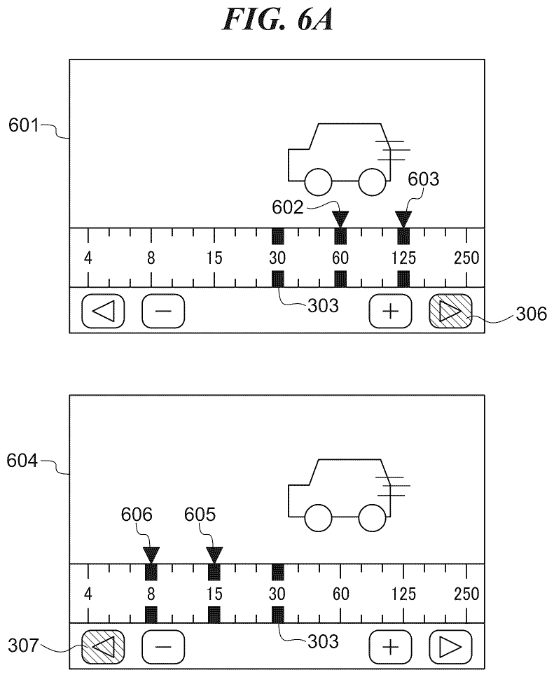

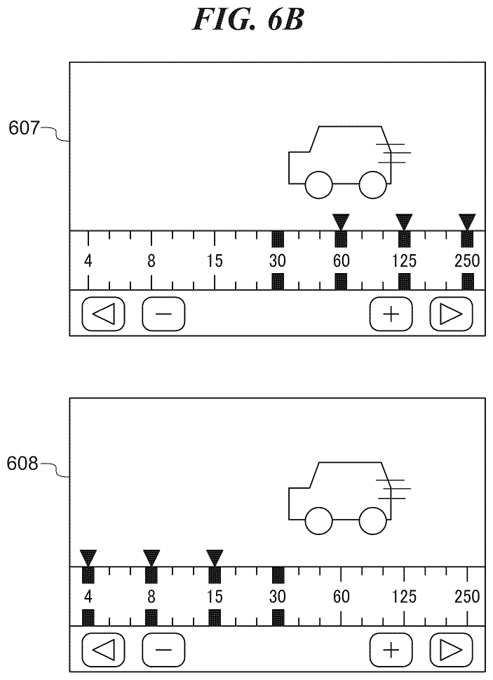

Here, a method of additionally saving the slow shutter images by the bracket photographing will be described with reference to FIG. 6A and FIG. 6B.

An exposure time setting screen 601 is an example in the case that the right arrow button 306 is pressed once on the exposure time setting screen 501 and images to be additionally saved by the bracket photographing have been set to the short exposure time side. In this case, by using the set exposure time 303 ( 1/30 second) as a reference, the exposure times of the slow shutter images to be additionally saved are set to an additionally-set exposure time 602 ( 1/60 second), which is ½ of the set exposure time 303 ( 1/30 second), and an additionally-set exposure time 603 ( 1/125 second), which is ¼ of the set exposure time 303 ( 1/30 second). On the exposure time setting screen 601, the right arrow button 306 becomes not to be able to be pressed.

An exposure time setting screen 604 is an example in the case that the left arrow button 307 is pressed once on the exposure time setting screen 501 and images to be additionally saved by the bracket photographing have been set to the long exposure time side. In this case, by using the set exposure time 303 ( 1/30 second) as a reference, the exposure times of the slow shutter images to be additionally saved are set to an additionally-set exposure time 605 ( 1/15 second), which is twice the set exposure time 303 ( 1/30 second), and an additionally-set exposure time 606 (⅛ second), which is four times the set exposure time 303 ( 1/30 second). On the exposure time setting screen 604, the left arrow button 307 becomes not to be able to be pressed.

In the case that the left arrow button 307 has been pressed on the exposure time setting screen 601, the screen returns to the exposure time setting screen 501. Similarly, in the case that the right arrow button 306 has been pressed on the exposure time setting screen 604, the screen returns to the exposure time setting screen 501.

It should be noted that in the present embodiment, as the additionally-set exposure times, by using the set exposure time 303 ( 1/30 second) as a reference, two exposure times have been set to the long exposure time side or the short exposure time side at a pitch of 1 EV, but as long as they are set at a pitch of a predetermined EV (for example, at a pitch of ⅓ EV or at a pitch of ½ EV), they do not have to be at a pitch of 1 EV. In addition, the interval of the pitch may be changeable by the user.

In addition, the right arrow button 306 on the exposure time setting screen 601 may be made pressable so that two or more additionally-set exposure times are capable of being set to the short exposure time side. In this case, when the right arrow button 306 on the exposure time setting screen 601 is pressed, the screen transitions to an exposure time setting screen 607. On the exposure time setting screen 607, by using the set exposure time 303 ( 1/30 second) as a reference, three additionally-set exposure times that are 1/60 second, which is ½ of the set exposure time 303 ( 1/30 second), 1/125 second, which is ¼ of the set exposure time 303 ( 1/30 second), and 1/250 second, which is ⅛ of the set exposure time 303 ( 1/30 second), are set.

In this way, by setting the additionally-set exposure times on the short exposure time side, the user becomes able to obtain images in which camera shake or the like has been suppressed.

Similarly, the left arrow button 307 on the exposure time setting screen 604 may be made pressable so that two or more additionally-set exposure times are capable of being set to the long exposure time side. In this case, when the left arrow button 307 on the exposure time setting screen 604 is pressed, the screen transitions to an exposure time setting screen 608. On the exposure time setting screen 608, by using the set exposure time 303 ( 1/30 second) as a reference, three additionally-set exposure times that are 1/15 second, which is twice the set exposure time 303 ( 1/30 second), ⅛ second, which is four times the set exposure time 303 ( 1/30 second), and ¼ second, which is eight times the set exposure time 303 ( 1/30 second), are set.

In this way, by setting the additionally-set exposure times on the long exposure time side, it becomes possible to prepare for the case where the effect of long time exposure is insufficient. As a result, for example, in the case that the user wishes to add a sense of movement (blurring) to a photograph, the user is able to save the image with a desired effect width.

In the step S409, the system control unit 210 sets the images to be additionally saved by the bracket photographing to the short exposure time side by using the exposure time that has been set in the step S401 as a reference. For example, in the case that the right arrow button 306 has been pressed on the exposure time setting screen 501, the screen transitions to the exposure time setting screen 601. As a result, the user is notified that the slow shutter images with the set exposure time 303 ( 1/30 second), the additionally-set exposure time 602 ( 1/60 second), and the additionally-set exposure time 603 ( 1/125 second) are capable of being obtained by the bracket photographing. After that, the image pickup processing returns to the step S401.

In the step S411, the system control unit 210 sets the images to be additionally saved by the bracket photographing to the long exposure time side by using the exposure time that has been set in the step S401 as a reference. For example, in the case that the left arrow button 307 has been pressed on the exposure time setting screen 501, the screen transitions to the exposure time setting screen 604. As a result, the user is notified that the slow shutter images with the set exposure time 303 ( 1/30 second), the additionally-set exposure time 605 ( 1/15 second), and the additionally-set exposure time 606 (⅛ second) are capable of being obtained by the bracket photographing. After that, the image pickup processing returns to the step S401.

In the step S412, the system control unit 210 (a determining unit) determines the split exposure time and the number of times of the consecutive photographing (a determining step). This determination is made based on the exposure time that has been set in the step S401, and the additionally-set exposure times in the bracket photographing, which have been set in at least one of the steps S404, S406, S409, and S411. After that, the image pickup processing proceeds to the step S413. It should be noted that in the flowchart shown in FIG. 4, there may be cases where the image pickup processing proceeds to the step S412 without making any setting in the steps S404, S406, S409, or S411, and in this case, the bracket photographing will not be performed.

In the step S413, the system control unit 210 determines whether or not a photographing instruction has been issued by pressing of the shutter button 102. In the case that a photographing instruction has been issued (YES in the step S413), the image pickup processing proceeds to the step S414. On the other hand, in the case that a photographing instruction has not been issued (NO in the step S413), the image pickup processing returns to the step S401, and returning to the state in which settings in the steps S401, S402, and S407 are accepted until a photographing instruction is issued. In addition, the photographing instruction is not limited to being issued by the shutter button 102, and for example, in the case that the display unit 101 is touch-operable, the photographing instruction may be issued by touching the display unit 101 (a touch shutter).

In the step S414, in response to the photographing instruction in the step S413, the system control unit 210 picks up (captures) a RAW image (a split exposure image) and stores it in the memory 206.

In the step S415, the system control unit 210 determines whether or not it is photographing of the first RAW image. In the case that it is photographing of the first RAW image (YES in the step S415), the image pickup processing proceeds to the step S417. On the other hand, in the case that it is photographing of one of the second and subsequent RAW images (NO in the step S415), the image pickup processing proceeds to the step S416.

In the step S416, based on a compositing unit set by the system control unit 210, the RAW images are composited by the image processing unit 205. After that, the image pickup processing proceeds to the step S417.

In the step S417, the system control unit 210 determines whether or not the RAW image or the composite image has reached a save setting time corresponding to either the exposure time that has been set in the step S401 or any one of the additionally-set exposure times in the steps S404, S406, S409, and S411. Here, the save setting time refers to the calculated exposure time of these images. In the case that the RAW image or the composite image has reached the save setting time (YES in the step S417), the image pickup processing proceeds to the step S418. On the other hand, in the case that the RAW image or the composite image has not reached the save setting time (NO in the step S417), the image pickup processing proceeds to the step S419.

In the step S418, the system control unit 210 (a saving unit) saves the image that has reached the save setting time in the recording medium 106. After that, the image pickup processing proceeds to the step S419.

In the step S419, the system control unit 210 determines whether or not all the images that have reached the save setting time corresponding to either the exposure time that has been set in the step S401 or any one of the additionally-set exposure times in the steps S404, S406, S409, and S411 (all images to be saved) have been saved. In the case that all images to be saved have been saved (YES in the step S419), the system control unit 210 ends the image pickup processing. On the other hand, in the case that all images to be saved have not been saved (NO in the step S419), the image pickup processing returns to the step S414, and the system control unit 210 (a split exposure unit) performs consecutive photographing with the image pickup unit 203 until all images to be saved are saved in the step S418, and executes split exposure that repeats compositing and saving of the image. It should be noted that, when performing this consecutive photographing, the system control unit 210 keeps the image pickup surface of the image pickup unit 203 in the exposed state without a non-exposed period.

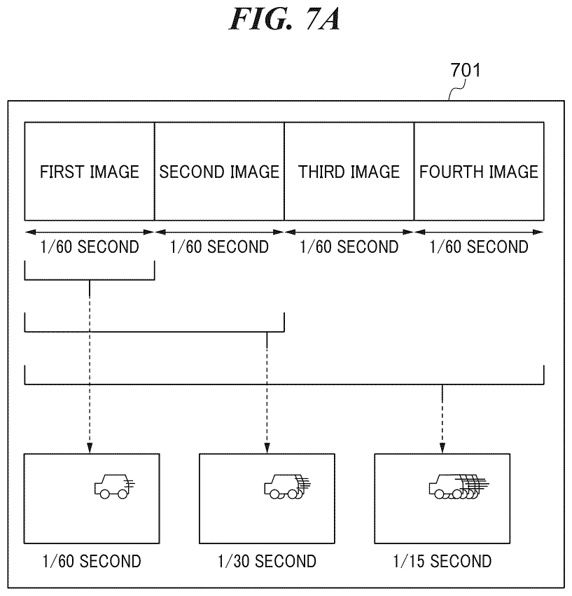

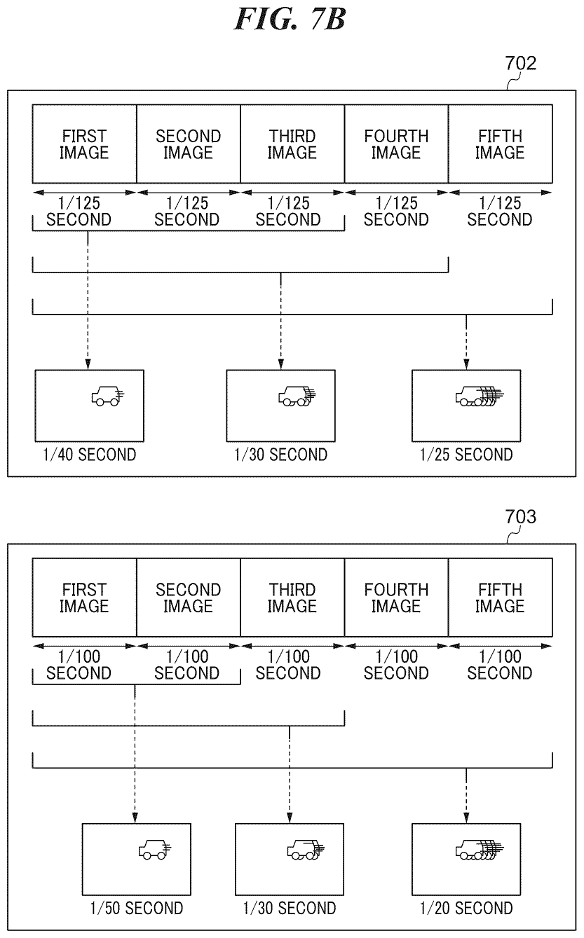

FIG. 7A and FIG. 7B are diagrams that show examples of the split exposure time, the number of times of the consecutive photographing, and image groups 701, 702, and 703 to be saved based on settings on the respective exposure time setting screens 501, 505, and 508 that are shown in FIG. 5.

The image group 701 is obtained by the system control unit 210 setting the split exposure time to 1/60 second and the number of times of the consecutive photographing to four based on the exposure time setting screen 501, and performing the consecutive photographing according to the settings. The image group 701 to be saved includes a 1/60 second image photographed by split exposure, a 1/30 second image equivalent to an image obtained by compositing two 1/60 second images, and a 1/15 second image equivalent to an image obtained by compositing four 1/60 second images.

The image group 702 is obtained by the system control unit 210 setting the split exposure time to 1/125 second and the number of times of the consecutive photographing to five based on the exposure time setting screen 505, and performing the consecutive photographing according to the settings. The image group 702 to be saved includes a 1/40 second image equivalent to an image obtained by compositing three 1/125 second images photographed by split exposure, a 1/30 second image equivalent to an image obtained by compositing four 1/125 second images, and a 1/25 second image equivalent to an image obtained by compositing five 1/125 second images.

The image group 703 is obtained by the system control unit 210 setting the split exposure time to 1/100 second and the number of times of the consecutive photographing to five based on the exposure time setting screen 508, and performing the consecutive photographing according to the settings. The image group 703 to be saved includes a 1/50 second image equivalent to an image obtained by compositing two 1/100 second images photographed by split exposure, a 1/30 second image equivalent to an image obtained by compositing three 1/100 second images, and a 1/20 second image equivalent to an image obtained by compositing five 1/100 second images.

With reference to FIG. 7A and FIG. 7B, as the examples, the cases of the settings on the exposure time setting screens 501, 505, and 508 and the split exposure time that the number of times of the consecutive photographing becomes the smallest number of times have been described, but the disclosure is not limited to those. In other words, if the split exposure time and the number of times of the consecutive photographing are such that the images to be saved, which are equivalent to images obtained with the set exposure times, are capable of being generated by image compositing and averaging processing, the split exposure time may be shortened and the number of times of the consecutive photographing may be increased to four or more. It should be noted that the split exposure time and the number of times of the consecutive photographing, for which the images to be saved, which are equivalent to the images obtained with the set exposure times, are capable of being generated, have been retained (stored) in advance in the nonvolatile memory 208 for each set exposure time to be saved.

For example, based on the exposure time setting screen 501, the system control unit 210 may set the split exposure time to 1/125 second and set the number of continuous shots to eight. In this case, the image group 701 to be saved includes a 1/60 second image equivalent to an image obtained by compositing two 1/125 second images, a 1/30 second image equivalent to an image obtained by compositing four 1/125 second images, and a 1/15 second image equivalent to an image obtained by compositing eight 1/125 second images.

In addition, based on the exposure time setting screen 505, the system control unit 210 may set the split exposure time to 1/250 second and set the number of continuous shots to ten. In this case, the image group 702 to be saved includes a 1/40 second image equivalent to an image obtained by compositing six 1/250 second images, a 1/30 second image equivalent to an image obtained by compositing eight 1/250 second images, and a 1/25 second image equivalent to an image obtained by compositing ten 1/250 second images.

Similarly, based on the exposure time setting screen 508, the system control unit 210 may set the split exposure time to 1/200 second and set the number of continuous shots to ten. In this case, the image group 703 to be saved includes a 1/50 second image equivalent to an image obtained by compositing four 1/200 second images, a 1/30 second image equivalent to an image obtained by compositing six 1/200 second images, and a 1/20 second image equivalent to an image obtained by compositing ten 1/200 second images.

In the present embodiment, the user is able to use the exposure time setting screen to set the exposure time that is a reference and also easily set the additionally-set exposure times of the slow shutter images that the user wishes to save by the bracket photographing. In addition, the system control unit 210 sets the split exposure time and the number of times of the consecutive photographing based on the settings on the exposure time setting screen, and generates and saves the images equivalent to images obtained with the set exposure times by repeating the consecutive photographing and the additive average compositing. As a result, it is possible to save a plurality of images with different slow shutter effects with one photographing instruction.

It should be noted that, in the above embodiment, the case that the image pickup apparatus according to the disclosure is a digital camera for personal use has been described, but the disclosure is not limited to this. In other words, as long as it is equipped with an image pickup function, an image compositing function, and a user interface for setting the exposure time, as the image pickup apparatus according to the disclosure, a mobile device, a smartphone, a network camera connected to a server, or the like may be applied. In addition, part of the above-described processing may be performed by the mobile device, the smartphone, the network camera connected to the server, or the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., ASIC) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-208564, filed on Dec. 11, 2023, which is hereby incorporated by reference herein in its entirety.

What is claimed is:

1. An image pickup apparatus that comprises an image pickup unit which picks up an image of a subject, comprising:
at least one processor; and
a memory coupled to the processor storing instructions that, when executed by the processor, cause the processor to function as:
an exposure time setting unit that, in a case of performing bracket photographing, sets a first exposure time and at least two exposure times, which are different from the first exposure time and use the first exposure time as a reference, in response to a user operation;
a determining unit that determines a split exposure time and a number of times of consecutive photographing of four or more in accordance with the first exposure time and the at least two exposure times that have been set by the exposure time setting unit;
a split exposure unit that performs the consecutive photographing with the image pickup unit based on the split exposure time and the number of times of the consecutive photographing of four or more that have been determined, and generates a plurality of split exposure images;
a compositing unit that composites the plurality of split exposure images generated by the split exposure unit in accordance with the first exposure time and the at least two exposure times that have been set by the exposure time setting unit to generate composite images; and
a saving unit that saves the plurality of split exposure images and the composite images composited by the compositing unit in accordance with the first exposure time and the at least two exposure times.

2. The image pickup apparatus according to claim 1, wherein
the exposure time setting unit includes an additional exposure time setting section that, in response to a user operation, sets additionally-set exposure times to both a short exposure time side and a long exposure time side at a predetermined setting interval by using the first exposure time as a reference, and
the at least two exposure times include two additionally-set exposure times that have been set by the additional exposure time setting section.

3. The image pickup apparatus according to claim 2, wherein
the additional exposure time setting section includes
a first interval changing section that increases the predetermined setting interval at a pitch of a predetermined EV in response to a user operation, and
a second interval changing section that decreases the predetermined setting interval at a pitch of the predetermined EV in response to a user operation.

4. The image pickup apparatus according to claim 1, wherein
the exposure time setting unit includes a short-exposure-time side exposure time setting section that, in response to a user operation, sets two or more additionally-set exposure times at a pitch of a predetermined EV to a short exposure time side than the first exposure time, and
the at least two exposure times include the two or more additionally-set exposure times that have been set by the short-exposure-time side exposure time setting section.

5. The image pickup apparatus according to claim 1, wherein
the exposure time setting unit includes a long-exposure-time side exposure time setting section that, in response to a user operation, sets two or more additionally-set exposure times at a pitch of a predetermined EV to a long exposure time side than the first exposure time, and
the at least two exposure times include the two or more additionally-set exposure times that have been set by the long-exposure-time side exposure time setting section.

6. The image pickup apparatus according to claim 1, wherein
when performing the consecutive photographing, the split exposure unit keeps an image pickup surface of the image pickup unit in an exposed state without a non-exposed period.

7. The image pickup apparatus according to claim 1, wherein
the compositing unit performs compositing by using any one of an additive compositing method, an additive average compositing method, a comparative light compositing method, and a comparative dark compositing method.

8. A control method for an image pickup apparatus that comprises an image pickup unit which picks up an image of a subject,
the control method comprising:
an exposure time setting step of, in a case of performing bracket photographing, setting a first exposure time and at least two exposure times, which are different from the first exposure time and use the first exposure time as a reference, in response to a user operation;
a determining step of determining a split exposure time and a number of times of consecutive photographing of four or more in accordance with the first exposure time and the at least two exposure times that have been set in the exposure time setting step;
a split exposure step of performing the consecutive photographing with the image pickup unit based on the split exposure time and the number of times of the consecutive photographing of four or more that have been determined, and generating a plurality of split exposure images;
a compositing step of compositing the plurality of split exposure images generated in the split exposure step in accordance with the first exposure time and the at least two exposure times that have been set in the exposure time setting step to generate composite images; and
a saving step of saving the plurality of split exposure images and the composite images composited in the compositing step in accordance with the first exposure time and the at least two exposure times.

9. A non-transitory computer-readable storage medium storing a program for causing a computer to execute a control method for an image pickup apparatus that comprises an image pickup unit which picks up an image of a subject,
the control method comprising:
an exposure time setting step of, in a case of performing bracket photographing, setting a first exposure time and at least two exposure times, which are different from the first exposure time and use the first exposure time as a reference, in response to a user operation;
a determining step of determining a split exposure time and a number of times of consecutive photographing of four or more in accordance with the first exposure time and the at least two exposure times that have been set in the exposure time setting step;
a split exposure step of performing the consecutive photographing with the image pickup unit based on the split exposure time and the number of times of the consecutive photographing of four or more that have been determined, and generating a plurality of split exposure images;
a compositing step of compositing the plurality of split exposure images generated in the split exposure step in accordance with the first exposure time and the at least two exposure times that have been set in the exposure time setting step to generate composite images; and
a saving step of saving the plurality of split exposure images and the composite images composited in the compositing step in accordance with the first exposure time and the at least two exposure times.

10. An image pickup apparatus that comprises an image pickup unit which picks up an image of a subject, comprising:
at least one processor; and
a memory coupled to the processor storing instructions that, when executed by the processor, cause the processor to function as:
a setting unit that allows a user to set a first exposure time and one or more second exposure times different from the first exposure time;
a determining unit that determines a split exposure time and a number of times of consecutive photographing in accordance with the first exposure time and the second exposure times that have been set by the setting unit;
a control unit that controls the consecutive photographing with the image pickup unit based on the split exposure time and the number of times of the consecutive photographing that have been determined;
a compositing unit that composites a plurality of split exposure images picked up based on the split exposure time determined in accordance with the first exposure time and the second exposure times that have been set by the setting unit to generate composite images; and
a saving unit that saves (records) the composite images corresponding to the first exposure time and the second exposure times.

11. A control method for an image pickup apparatus that comprises an image pickup unit which picks up an image of a subject,
the control method comprising:
a setting step in which a user sets a first exposure time and one or more second exposure times different from the first exposure time;
a determining step of determining a split exposure time and a number of times of consecutive photographing in accordance with the first exposure time and the second exposure times that have been set in the setting step;
a control step of controlling the consecutive photographing with the image pickup unit based on the split exposure time and the number of times of the consecutive photographing that have been determined;
a compositing step of compositing a plurality of split exposure images picked up based on the split exposure time determined in accordance with the first exposure time and the second exposure times that have been set in the setting step to generate composite images; and
a saving step of saving (recording) the composite images corresponding to the first exposure time and the second exposure times.

12. A non-transitory computer-readable storage medium storing a program for causing a computer to execute a control method for an image pickup apparatus that comprises an image pickup unit which picks up an image of a subject,
the control method comprising:
a setting step in which a user sets a first exposure time and one or more second exposure times different from the first exposure time;
a determining step of determining a split exposure time and a number of times of consecutive photographing in accordance with the first exposure time and the second exposure times that have been set in the setting step;
a control step of controlling the consecutive photographing with the image pickup unit based on the split exposure time and the number of times of the consecutive photographing that have been determined;
a compositing step of compositing a plurality of split exposure images picked up based on the split exposure time determined in accordance with the first exposure time and the second exposure times that have been set in the setting step to generate composite images; and
a saving step of saving (recording) the composite images corresponding to the first exposure time and the second exposure times.
